(19) United States
(12) Patent Application Publication
(10) Pub. No.: US 2004/0259060 A1
(43) Pub. Date: Dec. 23, 2004

(54) System and method for software learning

(76) Inventors: Vivek Kumar, Bangalore (IN); Gargi Basak, Bangalore (IN); Chrandrashekar Babu, Bangalore (IN)

Correspondence Address: GLENN PATENT GROUP, 3475 EDISON WAY, SUITE L, MENLO PARK, CA, 94025, US

(21) Appl. No.: 10/496,519

(22) PCT Filed: Nov. 22, 2001
(86) PCT No.: PCT/IB01/02198

(51) Int. Cl. G09B 19/00

(52) U.S. Cl. 434/118

(57) ABSTRACT

A network-based software-learning system operates independently of a user's computer by providing a protected learning environment. The learning environment, integrated into a backend server, includes user interface, software interface and communication interface. The software-learning system provides a system and methods that facilitates a user's acquiring “hands on” experience of any software-learning module without risking damage to either server or client machines.

A virtual workspace allows readers of technology books, in print or electronic format to execute sample code from the books, viewing the result instantly. Users write, compile and run real code as they acquire knowledge from the book. The software-learning system is enabled for learning compiled programming languages as well as interpreted languages, possessing a streaming capability that allows the user to view any type of output.

### BACKGROUND OF THE INVENTION

1. Field of the Invention

The present invention relates generally to the field of computer-based learning. More particularly, the present invention relates to a system and method for learning software that provides a programming environment for learning programming without requiring specific essential software installed on a user's machine.

2. Description of the Prior Art

Computer programming is generally learned on desktop computers that are equipped with the complete programming software, including compilers for converting the source code into executable code. For a novice user, installing all the required software, keeping track of all the various versions, updates and bug fixes, is a tedious, difficult and error-prone task. Additionally, the expense of acquiring multiple software licenses is considerable.

As Internet technologies proliferate, web-based software learning sites are emerging as an alternative to the conventional standalone desktop model of software learning. Typically, such web-based services rely on the entire software-learning program being stored on a server, which is then accessed by the user over a network connection, a conventional web browser serving as the client application. Often, the web-based services are free or very low cost. What's more, they eliminate the necessity and expense of acquiring the programming software and compilers.

An example of such a web-based service is found at “www.w3schools.com.” This site is devoted to learning web-based technologies such as HTML and JAVASCRIPT. The user selects from provided code snippets, which are run and the output displayed to the user. Additionally, the user may edit the code snippets and run the edited snippets. Such a site is limited, however to learning of web-based technologies; because it does not stream graphical objects to the client, such as user interface elements and bitmaps, the system is not extensible to learning of programs that create such elements. Additionally, it does not support the learning of compiled programming languages such as C or C++. Also, the system provides only limited source material; there is no way of providing instructional material from a variety of sources, such as a library of books on various software related subjects.

www.useractive.com provides a software-learning site, also devoted to learning various web-based technologies, such as JAVA and XML. Additionally, the capability of learning compiled languages is provided. To use the site, at the beginning of each session, the user downloads a browser application created with DHTML and JAVASCRIPT. The browser application calls a variety of server-side programs using CGI-scripting. While capability is expanded somewhat beyond the previous example, the use of browser-based technologies also limits the extensibility of this site. Streaming capability is limited only to text; it does not provide a facility to stream graphical objects from the server, preventing graphical interface elements from being displayed to the user. Additionally, as in the previous example, instructional material is limited; there is no capability of displaying material from a library of external resources, such as books.

Accordingly, it would be a great advantage to provide a network-based means for learning software that enables provision of a library of instructional resources, such as books and articles. It would be a great advantage if the code examples in these sources could be invoked at the click of a button within a secure working environment where they can be safely viewed, edited, compiled and run. It would be a further advantage if this secure working environment protected both the server and the client from damage due to user error. It would be advantageous to relieve a user, particularly a novice user, the inconvenience and expense of acquiring, installing and maintaining a number of different programming environments in different versions and releases. It would be desirable to provide the ability to stream both text and graphics from server to client, allowing the user to view graphical output, such as graphical user-interface elements and bitmaps. It would be useful to provide a system architecture that minimized delays due to network bottlenecks and server latency.

### SUMMARY OF THE INVENTION

In recognition of such needs, a preferred embodiment of the invention provides a network-based system and method for enabling rapid, intuitive software learning that operates independently of a user's computer by providing a protected learning environment. The learning environment, integrated into a backend server, includes a user interface, a software interface and a communication interface. The invented software-learning system provides a program and process that facilitates a user's acquiring “hands on” experience of any software-learning module without risking damage to either the server or the client machines.

Additionally, the invention provides a digital workspace that allows readers of technology books and articles, in either print or electronic format to execute sample code in the books and view the result instantly. In addition, users can write, compile and run real code as they acquire knowledge from the book. The invention is fully enabled for learning compiled programming languages as well as interpreted languages, database applications and client-server applications, possessing a streaming capability that allows the user to view both textual and graphical output. Both the server applications and the client applications employ a modular architecture, rendering the invention easily extensible.

The invention includes both ‘Learning’ and ‘Quiz’ modes. In the ‘Learning’ mode, a user can learn various technologies; in the ‘Quiz’ mode, users can take programming tests, where they can write, run, test and finally, submit programs that they have written for evaluation to the system. Additionally, the invention provides a debugging capability where they can analyze a program's working as it executes. An alternate embodiment provides an accompanying knowledge database and a standalone version of the invention provides an embodiment wherein all components of the system are installed on a freestanding computer.

### BRIEF DESCRIPTION OF THE DRAWINGS

FIG. 1 provides a top-level block diagram of a software-learning system, according to the invention;

FIG. 2 diagrams a server-side execution environment for an individual user in the software-learning system of FIG. 1, according to the invention;

FIG. 3 diagrams streaming of text-based and graphical output from the server to the client in the software-learning system of FIG. 1, according to the invention;

FIG. 4 provides a detailed block diagram of client-side components in the software-learning system of FIG. 1, according to the invention;

FIG. 5 provides a detailed block diagram of server-side components in the software-learning system of FIG. 1, according to the invention;

FIG. 6 diagrams a typical operational flow between client and server in the software-learning system of FIG. 1, according to the invention;

FIG. 7 provides a library view in a client-side user interface in the software-learning system of FIG. 1, according to the invention;

FIG. 8 shows a book view in the user interface of FIG. 7, according to the invention;

FIG. 9 illustrates a file view in the user interface of FIG. 7, according to the invention;

FIG. 10 shows the interface of FIG. 7 with the ‘File’ menu selected, according to the invention;

FIG. 11 shows the interface of FIG. 7 with the ‘Edit’ menu selected, according to the invention;

FIG. 12 shows the interface of FIG. 7 with the ‘View’ menu selected, according to the invention;

FIG. 13 shows the interface of FIG. 7 with the ‘Program’ menu selected, according to the invention;

FIG. 14 shows the interface of FIG. 7 in ‘Run’ mode with server output shown in a separate output window, according to the invention;

FIG. 15 shows the interface of FIG. 7 with the ‘Window’ menu selected, according to the invention;

FIG. 16 shows the interface of FIG. 7 with the ‘Help’ menu selected, according to the invention;

FIG. 17 shows a tool bar from the interface of FIG. 7, according to the invention;

FIG. 18 shows a ‘Debug’ menu, according to the invention; and

FIG. 19 shows the user interface of FIG. 7 with a ‘Quiz’ mode selected, according to the invention.

### DETAILED DESCRIPTION

The present invention provides a system and method for software learning that includes a virtual workspace integrated with a backend server, in which the workspace includes a user interface, a software interface and a communication interface. The virtual workspace consists of a programming environment on the user's computer that provides a look and feel that is an easy-to-use, simplified version of the actual programming environment in the context of any given programming language, but which does not permit alteration of important system files or other critical components of the user's computer's functioning, thus ensuring that files essential to the working of the user's computer are not damaged. The computer programs that the user writes execute on the backend server within a safe, protected environment, referred to herein as a sandbox, which ensures that the system files and other critical components on the server are not damaged as well.

Books for learning computer programming generally include examples of program code to illustrate the concepts and principles taught by the book. A single book may include hundreds of these “code snippets.” The invention allows a user to view all of the code examples provided in an external electronic learning module. The learning module may be an electronic or printed copy of a programming text, or a portion of a text, an article, or some other unit of instruction. Subsequently, the user may compile and run selected code snippets, and view the output. Thus, instead of confining a user's interaction with the text to passively perusing the text and studying the examples, the invention brings a programming text to life, facilitating rapid and intuitive software learning. In addition, users can write, compile and run their own code (or modified versions of existing code) as they acquire knowledge from the books. Furthermore, by placing all the required environments for each book on the server, it is ensured that the correct version of each software program is used (as required by that book), saving the user the trouble of acquiring, installing and maintaining different versions of the software. For example, one Java book may require JDK 1.2 while another may require JDK 1.3. Expecting the user to install both on his or her machine is time-consuming and error-prone.

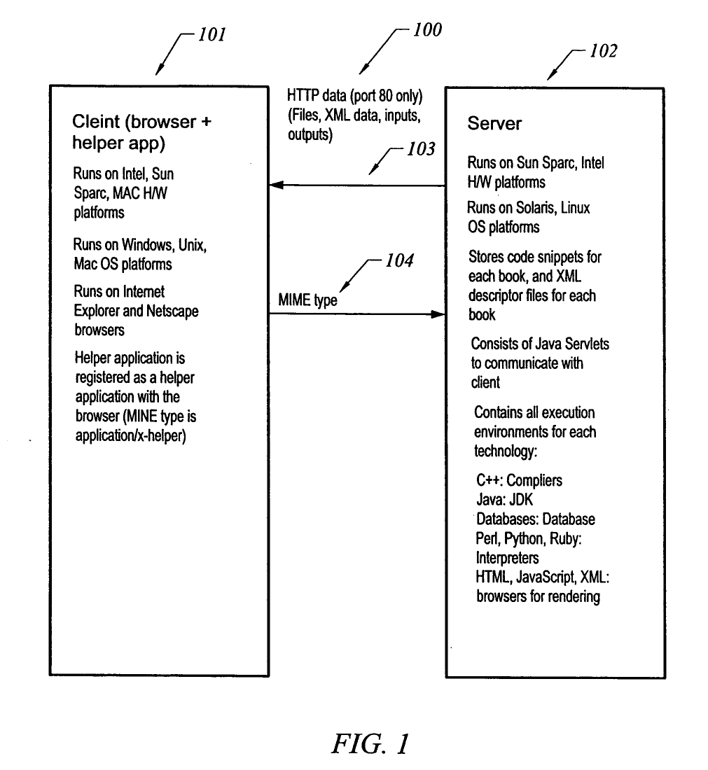

Turning now to the Figures, FIG. 1 provides a diagram of a client-server architecture of a network-based software-learning system 100, according to the invention. Generally, the invention includes a client 101 in communication with a server 102. The current embodiment of the invention requires only a minimal client-side installation. The client 101 includes a conventional web browser such as EXPLORER, supplied by Microsoft Corporation, or NAVIGATOR, supplied by America Online, Inc. of Mountain View Calif. USA. In addition to the browser, a helper application 600, including a number of separate components described in detail further below, provides a user interface for viewing code examples and interacting with the server 102. Finally, the client includes an applet, stored on the server 102 and downloaded to the client 101 as needed, that creates an output window 301, that allows a user to view the server output when the user compiles and runs a code snippet. The code snippets are selected from an external learning module such as an electronic version of a programming text that has been enabled for use with the invented software learning system. As described below, the selected code snippet is compiled and run on the server, and the server output is displayed on the client. Because code snippets are compiled and run on the server, the user is spared the difficulty and expense of having to acquire and install development environments on their own computer. As shown, a variety of hardware and operating system platforms are supported. On the client-side, compatible hardware platforms include, but are not limited to INTEL, manufactured by Intel Corporation of Santa Clara Calif. USA, SUN SPARC, manufactured by Sun Microsystems, Inc. of Palo Alto Calif. USA, and MAC, manufactured by Apple Computer, Inc. of Cupertino Calif. USA. Compatible operating systems include, but are not limited to WINDOWS provided by Microsoft Corporation of Redmond Wash. USA, the MAC OS, provided by Apple Computers, Inc., and UNIX.

On the server-side, hardware platforms include, but are not limited to SUN SPARC and INTEL. Compatible operating systems include, but are not limited to SOLARIS, provided by Sun Microsystems, Inc. and LINUX. The server stores XML descriptor files for each book, and the actual code snippets that are associated with the respective books. As previously described, the server contains execution environments for the various computing technologies; for example, C++ compilers, the JAVA Development Kit (JDK), database applications such as ORACLE, provided by Oracle Corporation of Foster City Calif. USA; interpreters for languages such as PERL, PYTHON and RUBY and web browsers for rendering HTML, XML, and JAVASCRIPT. Furthermore, server-side software includes a variety of JAVA servlets for communicating with the client. The current embodiment of the invention is implemented across a publicly accessible telecommunication network such as the Internet. However, other networked environments, such as local area networks (LAN's), wide area networks (WAN's) or virtual private networks (VPN's) are suitable as well.

The communications interface 103 between the client 101 and the server 102 may be by way of a conventional dial-up connection involving a modem. Additionally, other types of connections, such as DSL, ISDN, cable modem, satellite, or wireless are also suitable for the invention. The client and the server exchange HTTP data across the communications interface 103, including files, XML data, user inputs and server output. As mentioned above, the client includes a conventional web browser in concert with a second application 600, registered as a helper application. Book files sent to the client from the server are assigned a distinctive MIME type, for example ‘application/x-codesaw.’ When a user requests a book from the server, the server sends the MIME type 104, whereupon the browser invokes the helper application 600.

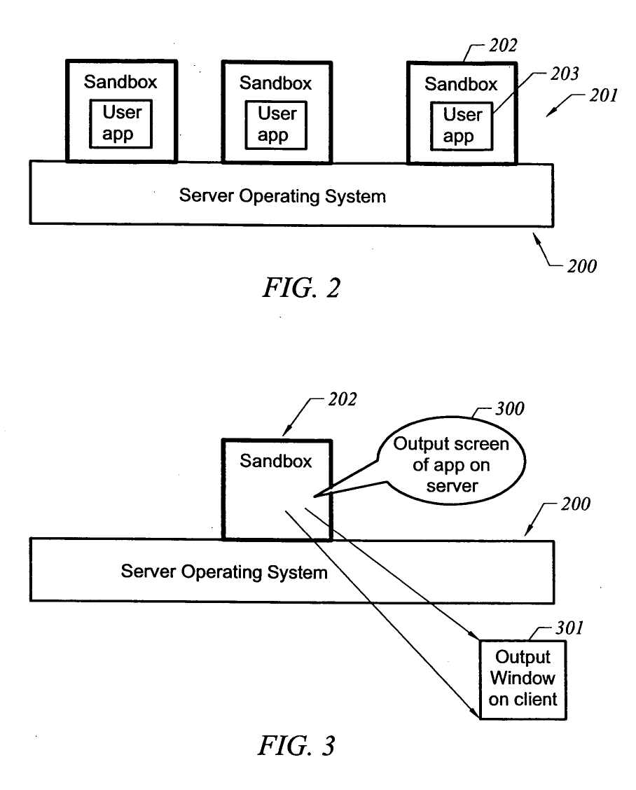

FIG. 2 shows another view of the server side, including an operating system layer 200 and an application layer 201. User programs 203 running on the server machine 102 run in a protected environment 202, referred to herein as a sandbox, that ensures the program uses system resources such as CPU, memory and disk in a tightly controlled manner. The sandbox also ensures the program does not violate security constraints defined on the server. For example, the program cannot start a virus or assume super-user (System Administrator) privileges or delete system files or files of other users, either intentionally or by mistake.

As shown in FIG. 3, server output is displayed on an output screen 300 on the server. As needed, an applet is downloaded from the server and run on the client to provide an output window 301 on top of the user interface 700 for viewing output streamed to the client from the server.

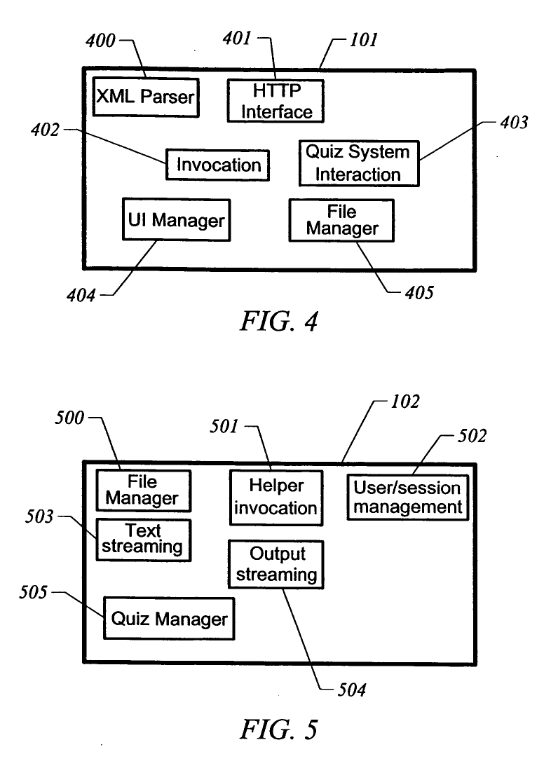

FIG. 4 provides a more detailed diagram of the various client-side software components:

XML Parser (400): Parses the XML descriptor file for each book and extracts the snippet-specific information;

HTTP Interface (401): mediates communication between client and server using HTTP protocol;

Helper application invocation component (402): loads the helper application upon receipt of the MIME type;

Quiz System Interaction component (403): Handles user submissions when the invention is being used in ‘Quiz’ mode (described further below);

UI Manager (404): Manages all UI components included tabbed panes, menu bars, file rendering, etc. (UI described below); and

File Manager (405): Handles uploads and downloads of files to and from the server, using the HTTP interface.

FIG. 5 provides a more detailed diagram of the various server-side components:

File Manager (500): Handles upload and download of files to and from the client;

Helper application invocation: (501) Sends file with MIME type (e.g. application/x-codesaw) to the client browser which in turn starts the helper application on the client machine;

User/Session Management (502): Whenever a client comes up, this component creates a session per invocation and manages all user files on the server; also manages timeouts;

Text Streaming (503): This component sends as text any compile time errors that may occur on the server.

Output Streaming (504): Gathers all application outputs (text and graphics) and streams it across to the client's output window.

Quiz Manager (505): Allows a user to take a test on the server, collects all answer submissions from the user and evaluates the answers and assigns scores based on expected outputs of each answer.

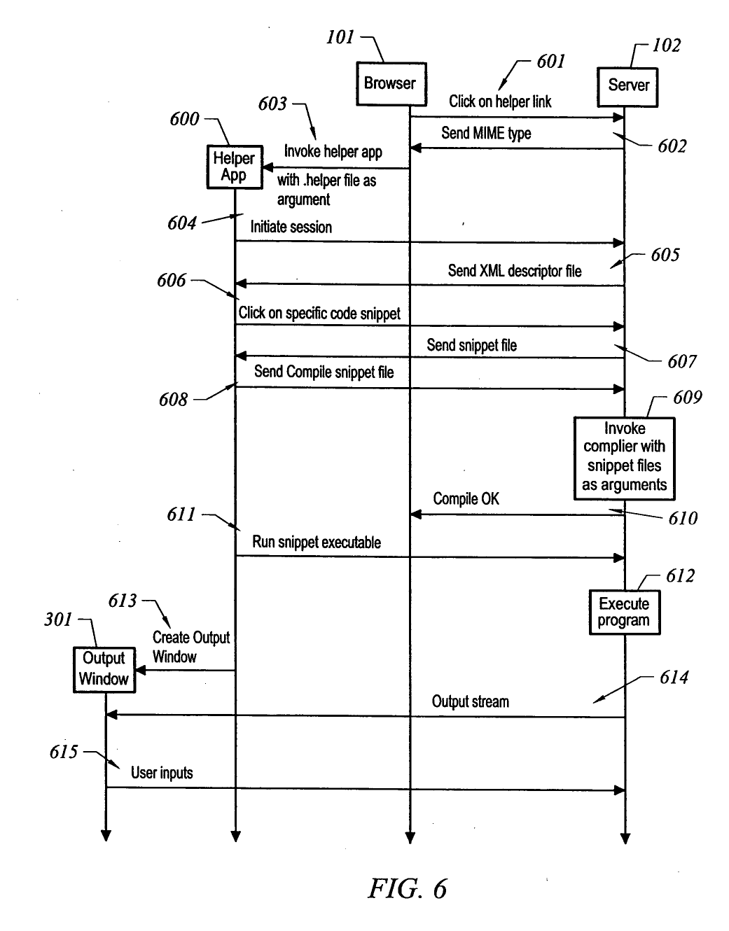

FIG. 6 provides a diagram of a typical operational flow between server and client during a user session. From the browser 101, a user activates a link 601. Typically, the link is an HTTP link associated with a file for a particular software text that has been enabled for use with the invention. In response to the HTTP request, the server sends the file's MIME type 602. Upon recognizing the MIME type, the browser invokes 603 the application 600. After being launched, the application 600 initiates a user session 604 on the server. In addition, the application provides a user interface, described in detail below, for viewing books and code examples, editing and writing code, and interacting with the server. After the user session is initiated, the server sends a XML descriptor file 605 for the book originally requested. After parsing of the XML file, a menu of code snippets available from that book is displayed to the user.

Clicking a link for a specific code snippet 606 causes a request for that snippet to be sent to the server. In response, the server sends the snippet file(s) 607. After the user views and studies the code snippet, the user sends a command to the server to compile the code snippet 608, whereupon the appropriate compiler is invoked 609 to compile the example code. When the compile operation is complete, confirmation is sent to the browser 610. At this point, the user sends a command to run the snippet executable 611, and the server executes the program 612. As the program executes, an output window 301 is created 613 on the client by means of an applet downloaded from the server. Additionally, other means of streaming output to the client may be employed. The program output, both textual and graphical, is streamed 614 from the server and displayed in the output window 301.

In the event that the displayed program requires user inputs, the user inputs are sent to the server 615.

The user's interaction is not limited to viewing of the code snippets provided. The user may edit the snippets, and view the edited snippets to see the effects of their edits. As the user's skills develop, he or she may also write their own code and compile and run it.

The invention also provides support for the development of client-server applications, i.e. applications that have separately executed client and server components. Using the invention, it is possible to compile and run the separate client and server components of the application on the server, and view the outputs of both programs at the same time on the client. For example, a user may be writing a Java RMI (remote method invocation) application that includes three different programs, one server and two clients.

The user first brings up the source code for the server, compiles it and runs it. Thus, the server code is being executed as a distinct program on the backend server, and its output window is created on the client machine. The user next brings up the source code for the first client, compiles and then runs it. It also begins execution as a distinct program on the same backend server, and a second output window is created on the client machine. Finally, the user brings up the source code for the second client, compiles it and then runs it. It also begins execution as a separate program on the same backend server, and a third output window is created on the client machine.

In this way, even though the three programs are running on the same backend server rather than separate client and server machines, they are still three distinct programs, each with their own flow of execution; and the three programs can communicate with each other in the manner specified by their respective source codes.

As mentioned above, the application 600 provides a user interface whereby the user peruses books and views code samples selected from those provided in the book. The user interface intentionally employs a simple design in order to allow users to familiarize themselves with the software learning system in a short time. Thus, by allowing users to concentrate on learning programming, rather than on learning how to use the system, they are able to progress in a rapid, intuitive manner from running simple programs to compiling, running and even debugging several client and server programs simultaneously, as described above, all from within the same interface.

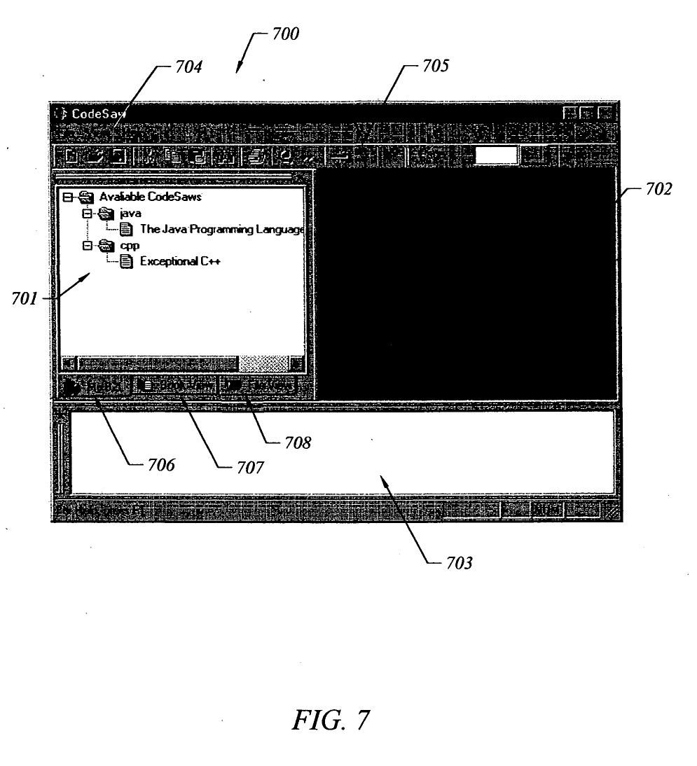

FIG. 7 provides a screenshot of the user interface. In general, the user interface includes a window having at least the following panes: a navigation pane 701, an editing pane 702 and a message page 703. The user interface further includes a menu bar 704 and a toolbar 705. As earlier described, the invention provides users with the opportunity to work interactively with an extensive library of texts dealing with a range of software related topics. The library typically is typically provided from a web site offering software texts that have been enabled for use with the software-learning system.

Different usage scenarios are possible. A user may have acquired a license to a single title in the collection by purchasing a hard copy. Other users may be subscribers who have paid a fee for access to the entire collection, or portions of the collection. In any case, before a user can access any of the books from the site, they must be running a JAVA-enabled browser on their computer and they must have previously installed the client software.

The user interface 700 provides different views, indicated by tabs 706, 707, 708 positioned below the navigation pane 701. FIG. 7 shows a ‘Library’ view, with the ‘Library’ tab 706 topmost. Each time a user downloads a book, it is registered on the user's machine, and it is listed in the navigation pane when the application is in ‘Library’ view. In ‘Library’ view, the complete menu of books downloaded by the user is displayed. It will be noted that, in ‘Library’ view, the editing pane 702 and the message pane are blank. As described above, the application 600 is invoked by the user requesting a book by clicking a hyperlink. Once the user has downloaded at least one book, the application may also be invoked by the user in a conventional manner, for example by clicking a desktop icon or selecting the application from a ‘Start’ menu. To select a book previously downloaded, the user opens the application from the desktop icon or the ‘Start’ menu and selects the book from the list displayed in ‘Library view.

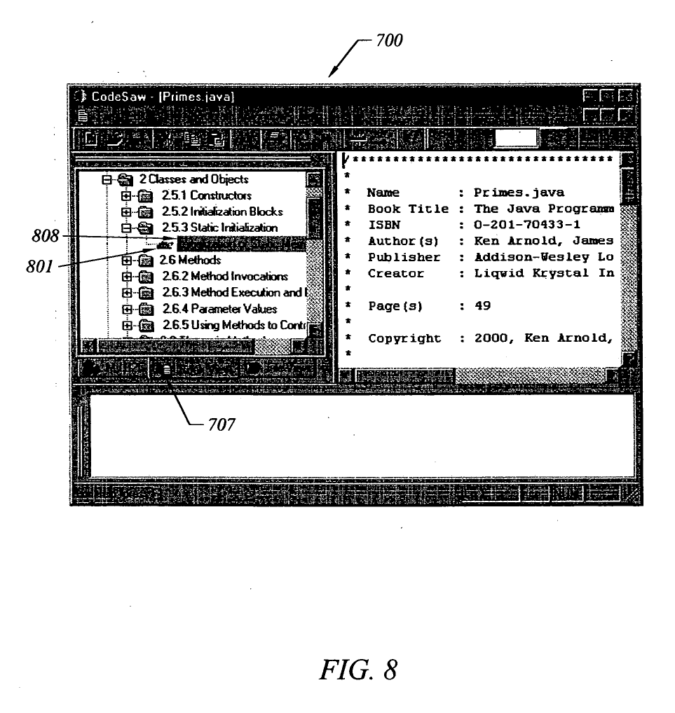

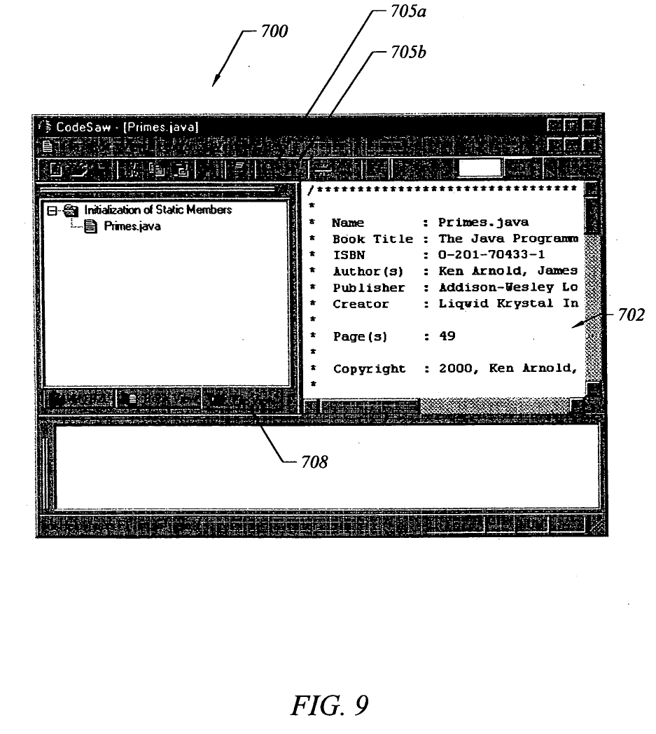

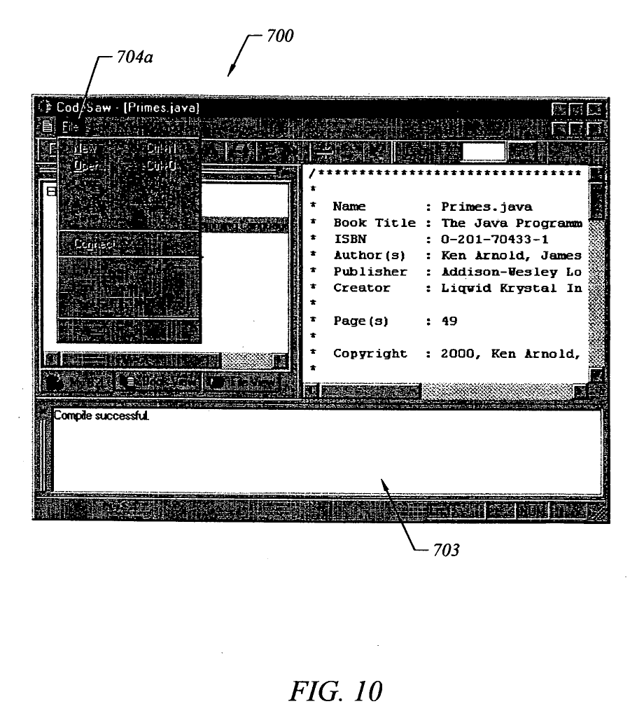

When a book is selected, the Editor pane 702 displays a “blurb” providing a brief description of the book. The book icon in the ‘Navigator’ pane 701 changes to ‘Open’ when a book is selected. After a book is selected, details of the book, i.e., chapter titles, section titles, and example titles are displayed in the navigator pane in ‘Book’ view, as shown in FIG. 8. In ‘Book’ view, the ‘Book’ view tab 707 is topmost. The display in the navigator pane takes the form of a conventional expandable hierarchy, with the actual code examples 800 being denoted by a distinctive icon 801. To view a code example, the user clicks the icon adjacent to the title of the code example, whereupon the user interface changes to ‘File’ view (FIG. 9).

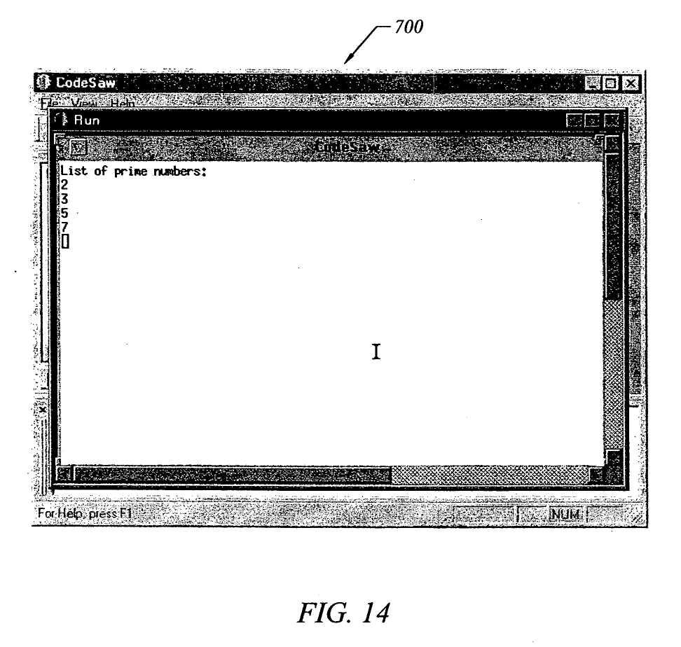

In ‘File’ view, the ‘File’ view tab 708 is topmost. When the icon 801 is clicked, a file representing that code example is downloaded from the server, and the complete, ready-to-run code snippet is loaded and displayed in the ‘Editor’ pane. The program can then be compiled by clicking the ‘Compile’ button 705a, at which point the code is compiled on the server as previously described. If the compile operation completes without errors, a ‘compile successful’ message appears in the message pane 703, as shown in FIG. 10. After compiling, the user runs the compiled code by clicking the ‘Execute’ button 705b, at which point the code executes on the server as previously described. As FIG. 14 shows, the resulting output is displayed in a separate output window 301, generated in the manner described above. In the event that either a ‘compile’ or ‘run’ operation is unsuccessful, error messages are also displayed in the message pane. It will be appreciated that the user is not confined to compiling and running the examples supplied with the book. As skills develop, the examples can be edited, and eventually the user is able to code real working programs using the programming environment provided by the invention.

FIG. 10 provides a view of the user interface 700 with the ‘File’ menu 704a selected.

Table 1 describes the functions of the various ‘File’ menu commands.

TABLE 1
File Menu Commands

| | |
|---|---|
| Save | Saves the active document using the current file name. |
| | Changes that are saved using either the Save icon or |
| | the Save option in the File menu, are available for the |
| | current session only |
| Save As | Saves the active document using a specified file name |
| | and location. Allows the user to save a personal copy |
| | of the displayed selection. |
| Close All | Closes all opened files belonging to the example. |
| Print | Prints the active file. On the File menu click Print to |
| | specify print options. |
| Print Preview | Displays the document on the screen, as it would |
| | appear when printed. |
| Recent Examples | Lists all the most recently opened files. To quickly |
| | open a file, simply click the file name in the list |
| | provided. |
| Exit | Closes the application window and exits the |
| | application. |

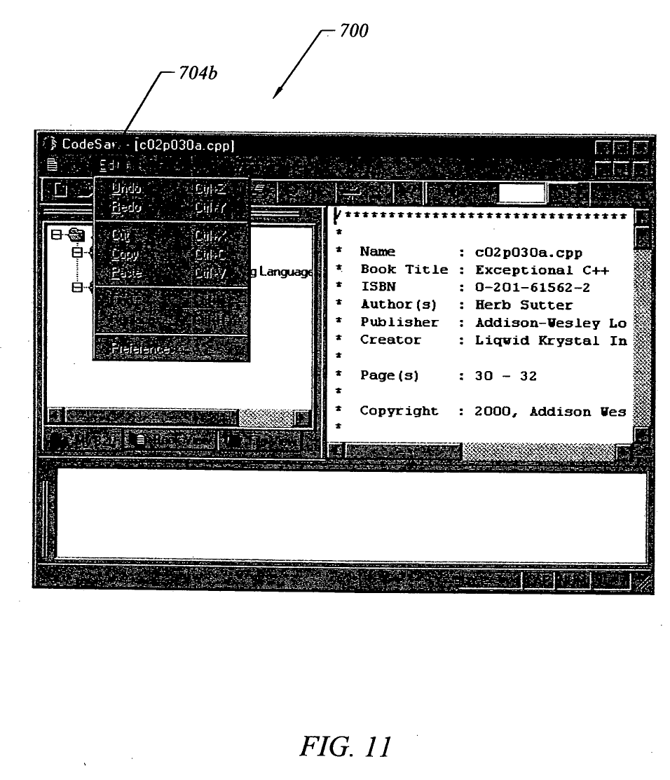

FIG. 11 shows a view of the user interface 700 with the ‘Edit’ menu 704b selected. The ‘Edit’ menu facilitates editing of programs loaded in the ‘Editor’ pane. The ‘Edit’ menu commands are summarized in Table 2, below.

TABLE 2
Edit Menu Commands

| | |
|---|---|
| Undo | Reverses the last action. |
| Redo | Reverses the action of the Undo command. To redo more |
| | than one action at a time, click the arrow next to the Redo |
| | command on the toolbar, and then select the actions that |
| | you want to redo. |
| Cut | Deletes data from the document and moves it to the |
| | Clipboard. |
| Copy | Copies data from the document to the Clipboard. |
| Paste | Inserts the contents of the Clipboard at the insertion point, |
| | and replaces any selection. This command is available only |
| | if you have cut or copied an object or text. |
| Find | Searches for the specified text or format. |
| Replace | Searches for and replaces the specified text or format. |
| Delete Book | Erases all information related to the specific book. |
| Preferences | Sets log in and proxy information. |

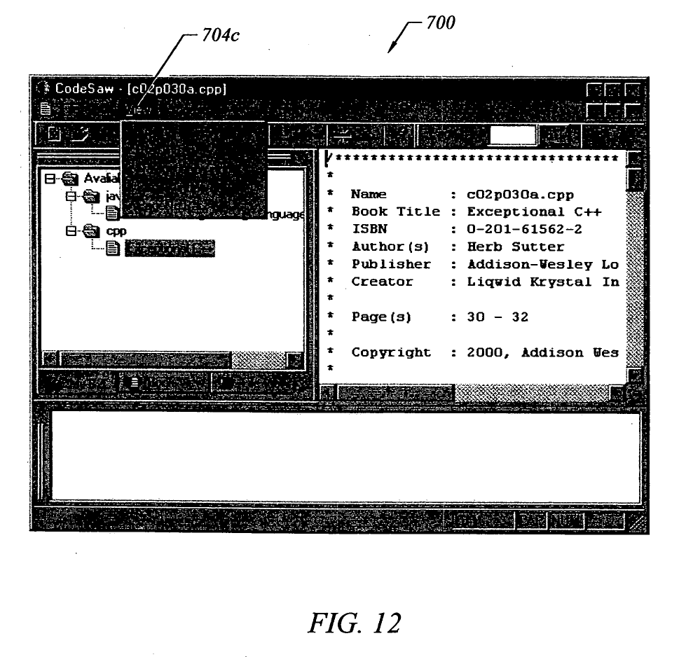

FIG. 12, shows a view of the user interface 700 with the ‘View’ menu 704c selected. Table 3, below, summarizes ‘View’ menu commands.

TABLE 3
View Menu Commands

| | |
|---|---|
| Toolbar | Shows or hides the toolbar. |
| Status Bar | Shows or hides the Status bar. |

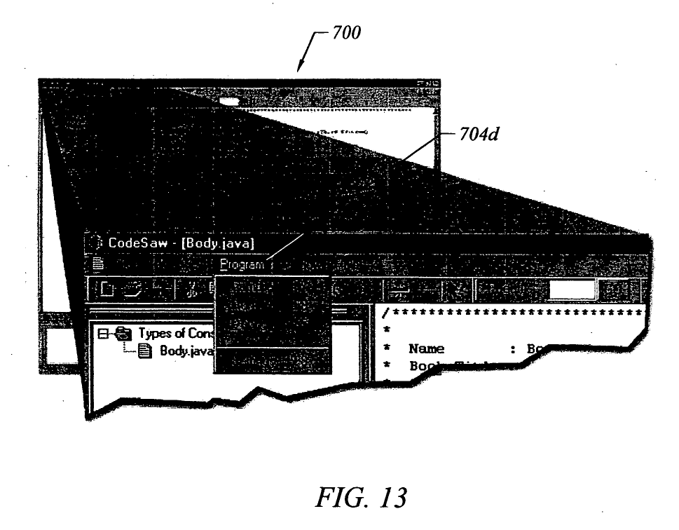

FIG. 13 provides a view of the user interface 700 with the ‘Program menu’ 704d selected. Table 4, below, summarizes ‘Program’ menu commands.

TABLE 4
Program Menu Commands

| | |
|---|---|
| Compile | Compiles active program file. |
| Run | Runs active program file. |
| Debug | Enables users to debug their programs by |
| | using the debug option. |
| Settings | Specifies settings for program. |

As previously described, FIG. 14 shows a view of the user interface 700 with the output of an executable program displayed in a separate output window 301. The output window is generated in the manner previously described.

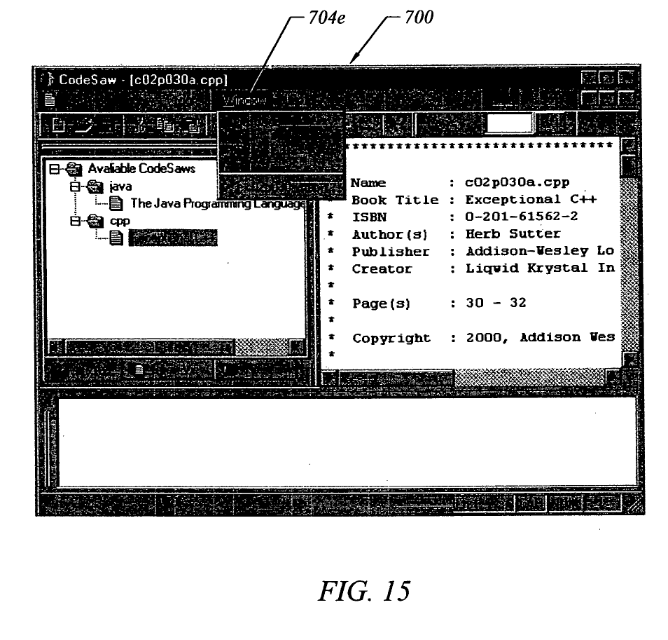

FIG. 15 shows a view of the user interface 700 with the ‘Window’ menu 704e selected. Table 5, below summarizes the ‘Window’ menu commands.

TABLE 5
Window Menu Commands

| | |
|---|---|
| Cascade | Arranges windows in an overlapped fashion. |
| Tile | Arranges windows in non-overlapped tiles. |
| Open Examples list | Displays list of all open examples. |

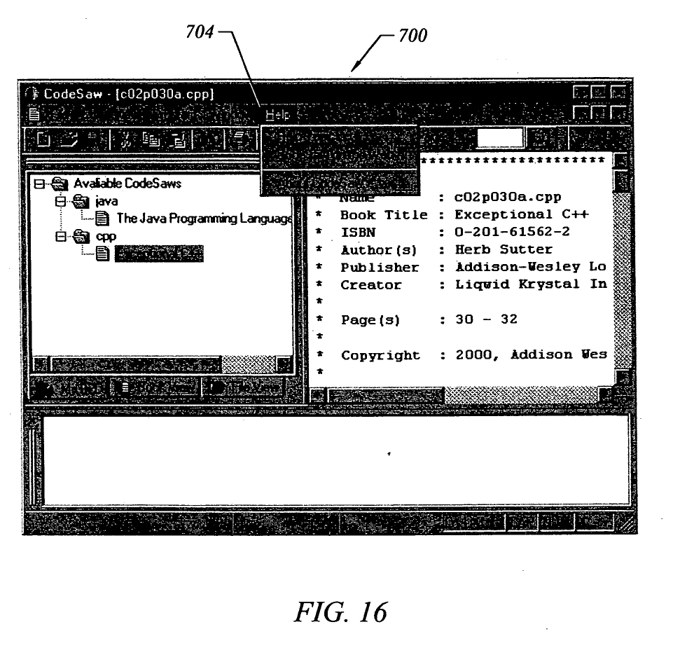

FIG. 16 shows a view of the user interface 700 with the ‘Help’ menu 704f selected. Table 6, below summarizes the ‘Help’ menu commands.

TABLE 6
Help Menu Commands

| | |
|---|---|
| CodeSaw Help | Provides information to help you accomplish |
| | your tasks. |
| What's This? | Provides context sensitive help. Click this icon to |
| | get help on specific tasks, functions, icons or |
| | buttons on CodeSaw. |
| CodeSaw on the Web | Displays list of all currently open examples. |
| About CodeSaw | Displays version number of CodeSaw, copyright |
| | and legal notices, the user and organization |
| | name. |

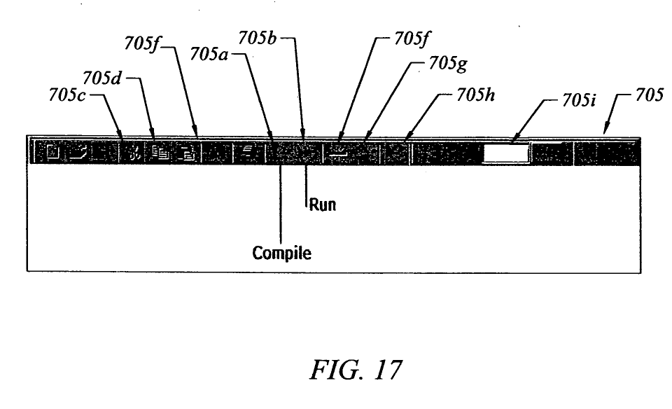

FIG. 17 shows a view of the toolbar 705 from the user interface 700. The toolbar allows the user to quickly perform important functions by clicking the appropriate icon in the toolbar. The toolbar has icons for ‘Cut’ 705c, ‘Copy’ 705d, ‘Paste’ 705e, ‘Compile’ 705a, and ‘Run’ 705b. A ‘Connect’ icon 705f toggles between connect/disconnect depending on the status of the network connection. A ‘Launch’ icon 705g starts the library in a default browser window. The ‘Help’ icon 705h gives rapid access to ‘Help’ topics; and finally the ‘Page number’ text box 705i allows a user to load the code examples that are present on the specified page in a book, if any.

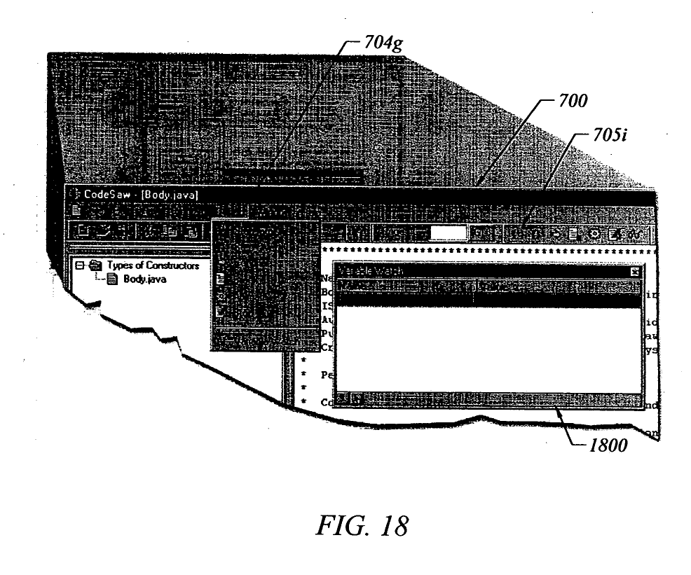

As shown in FIG. 13, the ‘Program’ menu includes a ‘Debug’ option, which allows users to debug programs they have written. Here the user can run the program line-by-line, set breakpoints, step into or over a line or function, examine variable values as the program executes, animate the program, etc. Selection of the ‘Debug’ option from the ‘Program’ menu causes creation of a ‘Debug’ menu 704g in the Menu bar 704, as shown in FIG. 18. Table 7, below summarizes ‘Debug’ menu commands. Additionally, an icon corresponding to each ‘Debug’ menu option appears on the toolbar 705, when the ‘Debug’ option is selected. The ‘Variable watch’ option generates a variable watch window 1800 as described in Table 7.

TABLE 7
Debug Menu Commands

| | |
|---|---|
| Step Into | Allows a user to debug a function by “going into” its |
| | lines of code and then debugging it line by line. |
| Step Over | Allows a user to debug a function in its entirety by |
| | “going over” it. |
| Continue | Allows a user to continue execution from at point at |
| | which it is currently stopped |
| Break | Allows a user to set a breakpoint at a given line in the |
| | code. When the program reaches that line, it pauses |
| | execution. |
| Animate | Allows a user to execute the program line by line without |
| | user intervention. |
| Stop | Allows the user to stop the execution of the program. |
| Variable Watch | Pops up the Variable Watch window which shows the |
| | values of all variables that the user is interested in. |

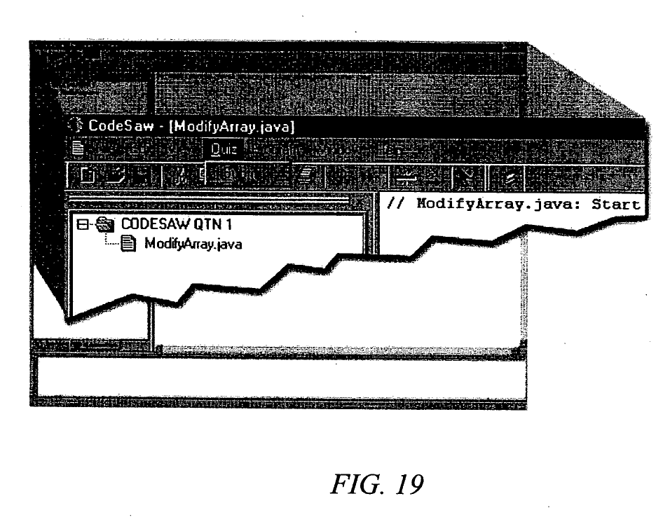

As shown in FIG. 19, the invention further provides a ‘Quiz’ mode. The application is provided with a quiz engine designed to operate using inbuilt program templates. This mode is used when the user is taking a quiz on programming concepts, in which they are expected to write, compile, run and finally submit for evaluation a fully working program, as part of the quiz question. The user uses the programming environment provided by the invention to do all of this. The server-side quiz interaction component 403 automatically evaluates the submitted program for correctness and grading.

While the invention has been described in a network context, employing a client-server architecture, the principles of the invention are applicable to other settings.

For example an alternative embodiment of the invention provides a standalone embodiment in which all components of the software learning system are installed on a freestanding computer. In such an embodiment, the software learning system may be provided on CD-ROM to a purchaser of a hard copy book, or an individual may purchase a suite of learning modules on a computer-readable medium that includes the standalone version of the software learning system. Thus, the entire environment is loaded on the freestanding machine including: all required development software i.e. compilers, databases, and so on. The content and code snippets of each module are available in HTML or XML on the freestanding machine and the user invokes the application by clicking on an icon embedded in the document. ‘Compile’ and ‘Run’ of each program occurs on the freestanding machine. In this embodiment, no server is involved. However, there may be instances where large-scale environments such as databases (e.g. Oracle) may still be required to be accessed on the server.

The invention is implemented using conventional methods of computer programming and programming languages known to those skilled in the arts of computer programming and software engineering. It should be noted that the invention has been described as having one server while, in fact, the server side may actually involve a number of different servers, for example, application servers, content servers, web servers, and database servers.

Although the invention has been described herein with reference to certain preferred embodiments, one skilled in the art will readily appreciate that other applications may be substituted for those set forth herein without departing from the spirit and scope of the present invention. For example, the invented system may be provided with a knowledge database, such as a digital library. Additionally, a facility may be provided for mailing selected files of a learning module to selected recipients, or to a newsgroup, listserv or bulletin board, or for interacting with a virtual community of users in other ways. Accordingly, the invention should only be limited by the claims included below.

1. A system for software learning, said system comprising:
at least one external software learning module;
a virtual workspace, wherein critical components of a user's computer are protected from damage resulting from user error, said workspace duplicating experience of computer programming without requiring installation of programming software on said user's computer; and
wherein said user accesses said learning module by means of said virtual workspace.

2. The system of claim 1, said system further comprising:
at least one server; and
a client in communication with said server;
said server including means for streaming graphical output to said client.

3. The system of claim 2, said server and said client communicating across any of:
a publicly accessible telecommunication network;
a local area network;
a wide area network; and
a virtual private network

4. The system of claim 2, said server and said client communicating through any of:
a dial-up connection;
a cable modem connection;
a DSL connection;
an ISDN connection;
a hard-wired network connection;
a wireless connection; and
a satellite connection.

5. The system of claim 2, wherein said virtual workspace comprises:
programming software installed on said server.

6. The system of claim 5, wherein said programming software includes any of:
at least one execution environment;
at least one compiler;
at least one interpreter;
at least one database-programming environment; and
at least one execution environment for Web technologies.

7. The system of claim 5, wherein said software runs in a protected environment, said protected environment comprising a sandbox, a separate sandbox provided for each user session, wherein said sandbox ensures a high degree of control over a program's use of system resources, and
wherein said sandbox ensures that said program does not violate server security constraints.

8. The system of claim 2, said server further comprising any of:
means for managing files;
means for sending a file MIME type to said client in response to a request for a file from said client, wherein receipt of said MIME type invokes an application providing a user interface;
means for generating an output window on said client;
means for streaming textual and graphical output to said client;
means for managing sessions and users; and
means for managing quizzes.

9. The system of claim 2, wherein said client comprises:
a web browser; and
a helper application, said helper application invoked upon receipt of an appropriate MIME type from said server.

10. The system of claim 9, said client further comprising any of means for parsing files included in said learning module;
a communications interface;
a quiz system interaction component;
a user interface manager; and
a file manager.

11. The system of claim 9, said virtual workspace further comprising a user interface, said user interface being generated by said helper application in concert with said browser.

12. The system of claim 11, wherein learning modules are stored on said server, a learning module including at least one descriptor file and a plurality of source code examples.

13. The system of claim 12, wherein a descriptor file comprises any of:
an XML file; and
an HTML file.

14. The system of claim 12, wherein a user requests a learning module by activating a corresponding link, wherein activating said link requests said module from said server.

15. The system of claim 12, wherein said learning module files have a unique MIME type, and wherein said server sends said MIME type to said client upon receiving a request for a learning module;
wherein receipt of said MIME type on said client causes invocation of said helper application, whereupon said user interface is generated.

16. The system of claim 15, wherein said helper application initiates a user session on said server, and requests a descriptor file for said requested learning module.

17. The system of claim 12, wherein a descriptor file received at said client is parsed, and at least a portion of said learning module is displayed in a pane of said user interface.

18. The system of claim 12, wherein a user requests one or more source code examples from a list of examples, and wherein said requested source code example is sent from said server and displayed in a pane of said user interface.

19. The system of claim 18, wherein a user sends a compile request to said server, wherein said requested source code example is compiled on said server.

20. The system of claim 18, wherein a user sends a run request to said server, wherein said compiled source code example is executed on said server.

21. The system of claim 20, said user interface further comprising a separate output window generated on said client as needed, and wherein output from said executed code is displayed in said output window.

22. The system of claim 17, wherein a user edits said source code example.

23. The system of claim 12, said user interface comprising means for loading code examples present on a specified page in said learning module.

24. The system of claim 12, wherein a user invokes said application.

25. The system of claim 24, wherein a user requests a learning module by selecting from a list of modules displayed in a pane of said user interface, wherein receipt of said request on said server initiates a user session.

26. The system of claim 24, wherein a user writes source code in an editing pane of said user interface.

27. The system of claim 26, wherein said source code is compiled and executed on said server, and output is displayed on said client in a separate output window as needed.

28. The system of claim 2, said virtual workspace further comprising means for debugging source code.

29. The system of claim 2, said virtual workspace further comprising a quiz mode.

30. The system of claim 2, said virtual workspace further comprising means for developing client-server applications, including means for any of writing, compiling, running and debugging a plurality of client and server programs simultaneously from within a single user interface.

31. A method for software learning, said method comprising the steps of:
providing at least one external software learning module;
providing a virtual workspace, wherein critical components of a user's computer are protected from damage resulting from user error, said workspace duplicating experience of computer programming without requiring installation of programming software on said user's computer; and
accessing said learning module by a user by means of said virtual workspace.

32. The method of claim 31, said step of providing a virtual workspace comprising the steps of:
providing at least one server; and
providing a client in communication with said server;
said server including means for streaming graphical output to said client.

33. The method of claim 32, said step of providing a virtual workspace further comprising the step of:
providing programming software installed on said server.

34. The system of claim 33, wherein said programming software includes any of:
at least one execution environment;
at least one compiler;
at least one interpreter;
at least one database-programming environment; and
at least one execution environment for web-based technologies.

35. The method of claim 33, said step of providing a virtual workspace further comprising the steps of:
running said software in a protected environment, said protected environment comprising a sandbox;
providing a separate sandbox for each user session, wherein said sandbox ensures a high degree of control over a program's use of system resources, and
wherein said sandbox ensures that said program does not violate server security constraints.

36. The method of claim 32, said step of providing a server comprising any of the steps of providing means for managing files;
providing means for sending a file MIME type to said client in response to a request for a file from said client, wherein receipt of said MIME type invokes an application providing a user interface;
providing means for generating an output window on said client;
providing means for streaming textual and graphical server output to said client;
providing means for managing sessions and users and;
providing means for managing quizzes.

37. The method of claim 32, wherein said step of providing a client comprises the steps of:
providing a web browser;
providing a helper application, and
invoking said helper application upon receipt of an appropriate MIME type from said server.

38. The method of claim 37, said step of providing a client comprising any of the steps of providing means for parsing files included in said learning module;
providing a communications interface;
providing a quiz system interaction component;
providing a user interface manager; and
a file manager.

39. The method of claim 37, said step of providing a virtual workspace further comprising the step of:
providing a user interface, said user interface being generated by said helper application in concert with said browser.

40. The method of claim 39, further comprising the step of storing learning modules on said server, a learning module including at least one descriptor file and a plurality of source code examples.

41. The method of claim 40, wherein a descriptor file comprises any of:
an XML file; and
an HTML file.

42. The method of claim 40, further comprising the step of
requesting a learning module by said user by activating a corresponding link, wherein activating said link requests said module from said server.

43. The method of claim 40, wherein said learning module files have a unique MIME type, further comprising the steps of
said server sending said MIME type to said client upon receiving a request for a learning module;
receiving said MIME type on said client;
invoking said helper application, and
generating said user interface.

44. The method of claim 40, further comprising the steps of:
initiating a user session on said server by said helper application, and
requesting a descriptor file for said requested learning module.

45. The method of claim 40, further comprising the steps of receiving a descriptor file at said client:
parsing said descriptor file; and
displaying at least a portion of said learning module in a pane of said user interface.

46. The method of claim 40, further comprising the steps of,
requesting one or more source code examples from a list of examples by a user;
sending said requested source code example from said server;
displaying said requested source code example in a pane of said user interface.

47. The method of claim 46, further comprising the steps of sending a compile request to said server by said user; and
compiling said requested source code example on said server.

48. The method of claim 47, further comprising the steps of
sending a run request to said server by said user; and
executing said compiled source code on said server.

49. The method of claim 48, said step of providing a user interface further comprising the steps of:
generating a separate output window as needed; and
displaying output from said executed code in said output window.

50. The method of claim 46, further comprising the step of:
editing said requested source code example by said user.

51. The method of claim 40, said step of providing a user interface comprising the step of:
providing means for loading code examples present on a specified page in said learning module.

52. The method of claim 40, further comprising the step of:
invoking said application by said user.

53. The method of claim 52, further comprising the step of:
requesting a learning module by a user by selecting from a list of modules displayed in a pane of said user interface; and
initiating a user session upon receipt of said request on said server.

54. The method of claim 53, further comprising the step of:
writing source code in an editing pane of said user interface by a user.

55. The method of claim 54, further comprising the steps of:
compiling said source code on said server;
executing said compiled code on said server;
generating a separate output window on said client as needed; and
displaying output of said executed code on said client in said separate output window.

56. The method of claim 32, said step of providing a virtual workspace further comprising the step of:
providing means for debugging source code.

57. The method of claim 32, said step of providing a virtual workspace further comprising the step of:
providing a quiz mode.

58. The system of claim 32, said step of providing a virtual workspace further comprising the step of:
providing means for developing client-server applications, including means for any of writing, compiling, running and debugging a plurality of client and server programs simultaneously from within a single user interface.

59. A computer program product comprising a tangible medium having computer-readable code embodied thereon, the computer readable code comprising code means for performing a method for software learning, said method comprising the steps of:
providing at least one software learning module;
providing a virtual workspace, wherein critical components of a user's computer are protected from damage resulting from user error, said workspace duplicating experience of computer programming without requiring installation of programming software on said user's computer; and
accessing said learning module by a user by means of said virtual workspace.

60. A software learning system, comprising:
at least one external software learning module;
an integrated programming environment, said programming environment including at least one of programming software, a compiler, an interpreter and an execution environment for at least one programming language or database application; and
a single user interface wherein a user accesses said learning module and said integrated programming environment.
